(19) United States
(12) Patent Application Publication
(10) Pub. No.: US 2026/0071607 A1
(43) Pub. Date: Mar. 12, 2026

(54) A WIND TURBINE BLADE WITH A SURFACE-MOUNTED DEVICE

(71) Applicant: LM WIND POWER A/S, Kolding (DK)

(72) Inventors: Jesper MADSEN, Kolding (DK); Jordy Hertel Nilsson VAN KALKEN, Kolding (DK); Horacio BULACIO, Kolding (DK); Hans MINNEE, Heerhugowaard (NL); Thomas MERZHAEUSER, Salzbergen (DE); Danial ASHOURI VAJARI, Kolding (DK)

(21) Appl. No.: 19/105,524

(22) PCT Filed: Aug. 22, 2023
(86) PCT No.: PCT/EP2023/073048

§ 371 Date: Feb. 21, 2025

(30) Foreign Application Priority Data
Aug. 22, 2022 (EP) 22191508.5

(51) Int. Cl. F03D 1/06

(52) U.S. Cl. CPC F03D 1/06495; F03D 1/0675; F05B 2240/3042; F05B 2240/3062

(57) ABSTRACT

A wind turbine blade has a profiled contour including a pressure side and a suction side, and a leading edge and a trailing edge with a chord extending therebetween. The blade extends in a spanwise direction between a root end and a tip end. The surface-mounted device is a leading edge protection panel attached to the leading edge of the wind turbine blade, the leading edge protection panel extending in the spanwise direction including: a first section extending from the leading edge and along a part of the pressure side of the wind turbine blade to a first transverse end at a first position on the pressure side of the blade, and a second section extending from the leading edge and along a part of the suction side of the wind turbine blade to a second transverse end at a second position on the suction side of the blade.

The present disclosure relates to a wind turbine blade with a surface-mounted device, and a method of manufacturing a wind turbine blade with a surface-mounted device. The present disclosure also relates to the field of protection of wind turbine blades against environmental influence, such as protection of the leading edge of wind turbine blades.

### BACKGROUND

Wind turbine blades are often provided with surface-mounted devices placed on a surface of the wind turbine blade, such as serration panels, or vortex generator panels, or leading edge panels, e.g. leading edge protection panels.

Such devices placed on the surface of the wind turbine blade may create a step-up and/or step-down situation for the airflow around it, e.g. from a base part of the surface-mounted device. The step-up or step-down situation creates a disturbance in the airflow that may increase drag and/or reduce lift, which may influence aerodynamic performance of the wind turbine blade in a negative way.

Therefore, it is desired to reduce such negative influence on the aerodynamic performance of the wind turbine blade.

Wind turbines need to be designed for operation for several years, e.g. at least 20 years. To maximise the annual energy production (AEP), it is important that the down-time of the wind turbine is minimised and intended AEP during use is maximised. During operation, the airfoil in the outboard region of the blade where critical erosion inset velocities are exceeded is subject to increased wear caused by impact of particles in the air. To reduce the wear and erosion on the leading edge, e.g. the erosion sensitive area of the wind turbine blade where particles in the air impact the blade at high speed due to the blade trajectories in operation, a protective element may be attached to the leading edge.

Although leading edge protection panels are meant for anti-corrosion protection, they may be damaged too fast themselves at high speed due to the blade trajectories in operation. Moreover, the leading edge erosion zone may move towards the downwind (suction) side of the wind turbine blade when wind speeds are increasing. This may influence the efficiency of anti-corrosion protection using known leading edge panels.

Therefore, it is desired to improve anti-corrosion protection using leading edge panels of the wind turbine blade in operation.

### SUMMARY

It is an object of the present disclosure to provide a wind turbine blade which overcomes or ameliorates at least some of the disadvantages of the prior art.

According to the invention, a wind turbine blade with a surface-mounted device, and a new method of manufacturing a wind turbine blade are provided, which may overcome or ameliorate at least one of the disadvantages of the prior art or which may provide a useful alternative.

Aspects of the present disclosure are as described in the following.

According to a first aspect a wind turbine blade is provided, wherein the blade comprises a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade, wherein the surface-mounted device comprises a base part, the base part providing a step in height from the exterior surface of the blade in the chordwise direction from a first side of the base part, wherein the blade further comprises a chamfer section configured to provide a multi-slope transition from the step in height of the base part to the exterior surface.

Accordingly, a variable chamfer section is formed, thus providing a multi-slope transition from the step in height of the base part of the surface-mounted device to the exterior surface of the wind turbine blade.

A transition or transition profile may thus be obtained in the chordwise direction of the wind turbine blade, which may be particularly advantageous in view of desired decrease of drag. The transition or transition profile may lower drag, thus reducing aerodynamic losses.

The cross-sectional shape of the chamfer section may thus reduce drag forces in the area of the surface-mounted device. Adapting the cross-sectional shape of the chamfer section in three dimensions and also varying height (thickness) and width in the spanwise direction, e.g. depending on spanwise location from root to tip of the blade, depending on aerodynamics gains and manufacturing cost and cycle time limitations provides an improved solution for the turbine wind blade with the surface-mounted device.

According to a second aspect, a method of manufacturing of a wind turbine blade is provided, the method comprising: arranging a surface-mounted device on an exterior surface of the blade, wherein a base part of the surface-mounted device provides a step in height from the exterior surface of the blade in the chordwise direction from a first side of the base part; and arranging a chamfer section configured to provide a multi-slope transition from the step in height of the base part to the exterior surface.

In the following, preferred embodiments according to the above aspects are described. The various embodiments may be combined in any conceived combination.

In this disclosure, a chamfer section configured to provide a multi-slope transition refers to a chamfer section that comprises two or more slope sections (or tapering sections) each with a different slope. For example, a chamfer section may be provided in which two or more sloping or taper angles may be detected and/or measured along respective sloping or tapering sections.

According to a preferred embodiment, a (maximum) width w of the chamfer section varies in the spanwise direction of the wind turbine blade. The varying width of the chamfer section in the spanwise direction of the blade may increase turbulence generation that may improve performance of the wind turbine generator.

In another preferred embodiment, the tapered section comprises a first concave portion proximal to the first side of the base part and a second convex portion distal to the first side of the base part. A variable sectional profile starting substantially flush and then concave from the base part and via a transition to a convex shape that lands substantially flush on the exterior surface of the blade in a certain distance reduces drag and/or noise and hence may improve lift of the resulting profile.

In another preferred embodiment, the chamfer section is configured to provide a curvilinear multi-slope transition from the step in height of the base part to the exterior surface. This may further enhance the positive aerodynamic properties of the transition.

In another preferred embodiment, the chamfer section comprises a tapered section, wherein the tapered section tapers in thickness away from the first side of the base part and comprises:
a first tapered section proximal to the first side of the base part and having a first average taper angle; and a second tapered section distal to the first side of the base part and having a second average taper angle different from the first taper angle. Such a transition profile may improve the aerodynamic properties of the chamfer section.

In yet another preferred embodiment, the chamfer section comprises a tapered section, and wherein the tapered section tapers in thickness away from the first side of the base part and comprises: a first tapered section proximal to the first side of the base part and having a first average taper angle; a third tapered section distal to the first side of the base part and having a third average taper angle; and a second tapered section between the first tapered section and the third tapered section and having a second average taper angle, wherein the second average taper angle is larger than both the first average taper angle and the third average taper angle. Accordingly, a variable tapered section of the chamfer section is formed, thus providing a transition from the step in height of the base part of the surface-mounted device to the exterior surface of the wind rotor blade. Thereby, also a transition may be obtained in the chordwise direction of the wind turbine blade, which may be particularly advantageous in view of desired decrease of drag. The curvilinear transition may lower drag, thus reducing aerodynamic losses. Further, the solution allows the tapered section to be manufactured separately, which may optimize the manufacturing process.

In one embodiment, the height or the thickness of the chamfer section does not increase in any sections from the first side of the base part of the surface-mounted device to the exterior surface of the wind rotor blade. In another embodiment, the height or the thickness of the chamfer section decreases monotonously from the first side of the base part of the surface-mounted device to the exterior surface of the wind rotor blade.

According to a preferred embodiment, the chamfer section, or e.g. the tapered section of the chamfer section, has a substantially S-shaped or stretched S-shaped profile in the chordwise direction of the blade. Such a profile may be particularly advantageous for reducing the likelihood of destruction of the chamfer section

According to a preferred embodiment, a width w of the chamfer section varies in the spanwise direction of the wind turbine blade. For example, the width w, along the spanwise direction, of the chamfer element can vary such as to form a sinusoidal pattern, a wavy pattern, or a repeating S-shape pattern along the spanwise direction of the blade, as shown, for example, in FIG. 10. Alternatively, the chamfer element width w can vary in the spanwise direction such as to form a zigzagging (e.g., a repeating triangular shape) pattern in the spanwise direction of the blade. Such a spanwise pattern may increase the generation of turbulence and thus may increase performance of the wind turbine generator. Further, the variation in the spanwise direction may cause a modulation of the wind flow over the chamfer section, which in turn can lower noise. The chamfer section may for instance be designed such that the pattern provides local maximum widths at various positions in the spanwise direction. The longitudinal distance between such local maximum widths may preferably lie in the range from 1-50 cm, more preferably in the range 2-25 cm, and even more preferably in the range 3-20 cm, e.g. around 10 cm.

In a preferred embodiment, the first average taper angle, the second average taper angle, and the third average taper angle are varying angles. This provides the variable form of the tapered section, which makes it possible to achieve a more flexible solution in view of aerodynamics performance.

According to another preferred embodiment, the first side of the base part of the surface-mounted device is rectilinear, and the tapered section has a first rectilinear side adjacent to the first rectilinear side of the base part. The first rectilinear side of the tapered section is particularly advantageous for providing an improved contact of the tapered section with the base part. An improved transition from the base part to the tapered section, e.g. without space or step up/down, is thus provided.

According to a preferred embodiment, the chamfer section substantially abuts the base part of the surface-mounted device and extends substantially flush from the first side of the base part. Since no overlapping between the chamfer section and the base part is present in this embodiment, the chamfer section extending substantially flush from the base part provides a smooth transition to the exterior surface of the wind rotor blade.

According to another preferred embodiment, the thickness (or the height) of the tapered section decreases uniformly from the first side of the base part of the surface-mounted device to the exterior surface of the blade.

According to another preferred embodiment, the chamfer section substantially abuts the exterior surface of the blade, or for example the first convex portion of the tapered section of the chamfer section, and curvilinearly transitions into the exterior surface of the blade. Since no gap between the chamfer section and the blade is present in this embodiment, an improved connection between the chamfer section and the exterior surface of the blade without spaces or surface irregularities is provided. In practice, this can be accomplished by for instance using a thin double-adhesive tape to adhere the chamfer section to the surface of the blade.

In yet another preferred embodiment, the chamfer section is integrally formed with the surface-mounted device. The surface-mounted device is thus manufactured or pre-assembled as a single piece with the chamfer section and then arranged on the exterior surface of the wind rotor blade. This may make it easier to arrange the surface-mounted device on the blade surface.

The chamfer section may preferably be a section or element, e.g., a separate section or element, arranged on the exterior surface of the blade in contact with the first side of the base part. The chamfer section is thus formed separately from the surface-mounted device and arranged on the exterior surface of the blade in contact with the surface-mounted device. The separate chamfer section provides more flexibility in using the surface-mounted device, since any surface-mounted device may be applied on the exterior surface of the wind rotor blade and then the chamfer section is arranged to provide the multi-slope transition therebetween. This also makes it possible to retrofit separate sections or elements to a blade, which is already provided with a surface-mounted device. The chamfer section preferably has a height to width ratio in the range 1:2 to 1:60, more preferably in the range 1:5 to 1:30, e.g., around 1:20. This provides a relatively shallow angle for the overall chamfer section and thus provides an improved transition for lowering drag and/or noise.

The thickness of the base of the surface-mounted device, which defines maximum of the thickness/the height of the chamfer section in the chordwise direction, is preferably in the range of 0.2-10 mm, more preferably in the range of 0.4-5 mm, and even more preferably in the range 0.5-2 mm.

The width of the chamfer section preferably is between 3 mm and 20 mm, more preferably between 5 mm and 15 mm, e.g., around 12 mm.

The length of the chamfer section preferably is between 10 mm and 5000 mm, more preferably between 30 mm and 2000 mm, e.g., around 700 mm, or e.g., around 500 mm.

The chamfer section advantageously comprises a top cover. The top cover may be a sealing top cover or a smoothing top cover. Different types of surface protection coatings could also be provided on the chamfer section. This can provide an improved transition to the base part of the surface-mounted device.

The surface-mounted device is preferably one of the following: a leading edge panel; a clip-on leading edge panel; a vortex generator panel; a spoiler panel; a serration panel on a trailing edge of the blade. Different possible surface-mounted devices or base parts to be provided on the blade surface could be implemented in combination with the current disclosure.

In the above-mentioned method arranging the chamfer section may further comprise providing a tapered section of the chamfer section, wherein the tapered section tapers in thickness away from the first side of the base part. Accordingly, the reduced manufacturing costs along with the improved aerodynamics characteristics are provided due to the claimed solution allowing for the use and manufacture of a separate tapered section.

In the above-mentioned method, arranging the chamfer section may further comprise providing a chamfer section with a (maximum) width w that varies in a spanwise direction of the wind turbine blade.

Accordingly, a manufacturing method providing reduced aerodynamic losses and/or noise is provided.

The above-mentioned method may comprise a 3-D printing step, and/or a 5-axis printing step and/or a 5-axis milling step to provide the chamfer section having the tapered section. A device or machine combining the 3-D or 5-axis printing or 5-axis milling could be used in combination with an earlier determined optimum chamfer profile. Using a 3-D or 5-axis printing or 5-axis milling techniques allows the cross-sectional profile of the chamfer section to vary in shape and width depending on the actual profile of the blade in the spanwise direction, independently of upwind (pressure) side and downwind (suction) side, thus contributing to optimizing the aerodynamic and acoustic performance.

The method may also comprise the step of molding the chamfer section by injection and curing of a liquid material to manufacture the chamfer section.

According to a third aspect, a wind turbine blade is provided, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade, wherein the surface-mounted device is a leading edge protection panel attached to the leading edge of the wind turbine blade, the leading edge protection panel extending in the spanwise direction and comprising: a first section extending from the leading edge and along a part of the pressure side of the wind turbine blade to a first transverse end at a first position on the pressure side of the blade, the first section having a first extent from the leading edge of the wind turbine blade to the first position on the pressure side of the blade, and a second section extending from the leading edge and along a part of the suction side of the wind turbine blade to a second transverse end at a second position on the suction side of the blade, the second section having a second extent from the leading edge of the wind turbine blade to the second position on the suction side of the blade, and the first extent and the second extent have varying lengths in the spanwise direction, and a ratio between the second extent and the first extent varies in the spanwise direction.

Accordingly, a wind turbine blade is provided with a center of the leading edge protection changing in the spanwise (longitudinal) direction (e.g. with respect to the leading edge). In this way, the leading edge protection panel is centered towards downwind (suction) side of the wind turbine blade, and the location of the leading edge protection panel is optimized according to the wind speed and direction.

Due to varying lengths of the first extent and the second extent and due to varying ratio between the two extents, the location of the leading edge protection panel is optimized to cover the moving leading edge erosion zone in movement. The optimized location of the leading edge protection panel is centered towards the downwind (suction) side of the wind turbine blade.

Shifting the leading edge protection panel, e.g. shifting of the center of the leading edge protection panel in the downwind direction, depending on the velocity and direction of the wind basically provides a twisted geometry (geometric twist) of the leading edge protection panel, which provides optimized location of the leading edge protection panel. It is particularly advantageous in view of an improved anti-corrosion protection, particularly during operation of the wind turbine blade at high wind speed.

Optimizing the location of the leading edge protection panel and varying the center of the leading edge protection panel, e.g. depending on the wind speed, provides an improved solution for the wind turbine blade with the surface-mounted device.

The first extent and/or the second extent may be measured in the chordal direction. The first and/or the second extent may be measured along the chord starting from the leading edge. Alternatively, the extent may be measured in the circumferential direction, e.g. along the outer surface of the blade shell parts, e.g. the extent may be expressed as the arc length.

The first position may be located at the boundary of the erosion sensitive area of the wind turbine blade in an inboard portion of the wind turbine blade. The second position may be located beyond the boundary of the erosion sensitive area of the wind turbine blade in the inboard portion of the wind turbine blade. The inboard portion of the wind turbine blade is the portion of the wind turbine blade proximal to the root end of the wind turbine blade.

The first position may be located beyond the boundary of the erosion sensitive area of the wind turbine blade in an outboard portion of the wind turbine blade. The second position may be located at the boundary or beyond the boundary of the erosion sensitive area of the wind turbine blade in the outboard portion of the wind turbine blade. The outboard portion of the wind turbine blade is the portion of the wind turbine blade proximal to the tip end of the wind turbine blade.

In a preferred embodiment of the wind turbine blade, the ratio between the second extent and the first extent varies from 1:1 to at least 1.5:1. The ratio between the first extent and the second extent may be between 1:3-1:6, e.g. the second extent may be between 3-6 times longer than the first extent. The first extent and/or the second extent may be measured along the chord starting from the leading edge.

The second section may extend, e.g. in a chordwise direction, along at least 20% of the chord of the wind turbine blade along at least an inboard portion of the leading edge protection panel, such as at least 30% of the chord of the wind turbine blade, such as at least 50% of the chord of the wind turbine blade. For example, the second section may have an extent between 40-45% of the chord of the wind turbine blade along at least a longitudinal portion of the leading edge protection panel, such as the inboard portion.

The second section may extend along at least 30% of the chord of the wind turbine blade along at least an outboard portion of the leading edge protection panel, such as at least 40% of the chord of the wind turbine blade, such as at least 50% of the chord of the wind turbine blade.

The first section may extend, e.g. in the chordwise direction, along at least 5% of the chord of the wind turbine blade along at least the inboard portion of the leading edge protection panel, such as at least 15% of the chord of the wind turbine blade, such as at least 30% of the chord of the wind turbine blade.

The first section may extend, e.g. in the chordwise direction, along at least 20% of the chord of the wind turbine blade along at least the outboard portion of the leading edge protection panel, such as at least 40% of the chord of the wind turbine blade, such as at least 70% of the chord of the wind turbine blade.

The first extent and the second extent may have a total extent between 260-1200 mm, such as between 300-850 mm, such as around 400 mm, such as around 800 mm. The total extent may be measured in the chord wise direction or in the arch length direction of the wind turbine blade. The total extent may increase between the outboard end to the inboard end, such as along at least the outboard portion. For example, the outboard portion may have a substantially triangular or trapezoidal shape. The outboard portion may have a substantially right-angled triangular shape. The total extent may be constant along at least between the outboard end to the inboard end, such as along at least the inboard portion. For example, the inboard portion may have a substantially rectangular shape. The total extent of the inboard portion may be larger than the total extent of the outboard portion. For example, the total extent of the inboard portion may be around 800 mm at maximum and the total extent of the outboard portion may be 400 mm at maximum. A chordal distance between the first transverse end and the second transverse end may increase from the outboard end to the inboard end, such as along at least the inboard portion and/or the outboard portion.

The wind turbine blades and the method of manufacturing described in this section may optionally be supplemented by any of the features, functionalities and details disclosed herein (in the entire document), both individually and taken in combination.

### BRIEF DESCRIPTION OF THE FIGURES

Embodiments of the disclosure will be described in more detail in the following with regard to the accompanying figures. The figures show one way of implementing the present disclosure and are not to be construed as being limiting to other possible embodiments falling within the scope of the attached claim set.

FIG. 1 shows a wind turbine,

FIG. 2 shows a schematic view of a wind turbine blade,

FIG. 3 shows a schematic view of a wind turbine blade with a leading edge panel,

FIG. 4 shows a schematic view of a wind turbine blade with a leading edge panel,

FIG. 5 shows a schematic view of a wind turbine blade with a serration panel,

FIG. 6 shows a schematic view of a wind turbine blade with a serration panel,

FIG. 7 shows a schematic view of a wind turbine blade with a vortex generator panel,

FIG. 8 shows a schematic sectional view of a chamfer section,

FIG. 9 shows a sectional view of a chamfer section,

FIG. 10 shows a top view of a chamfer section,

FIG. 11 shows steps in a manufacturing method,

FIG. 12 shows a schematic view of different types of a chordwise cross-sectional profile of a chamfer section,

FIG. 13 shows a schematic view of a wind turbine blade with a leading edge protection panel,

FIG. 14 shows a schematic view of varying lengths of the first and second extents of a leading edge protection panel.

### DETAILED DESCRIPTION

Various exemplary embodiments and details are described hereinafter with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

In the following, a number of exemplary embodiments are described in order to understand the invention.

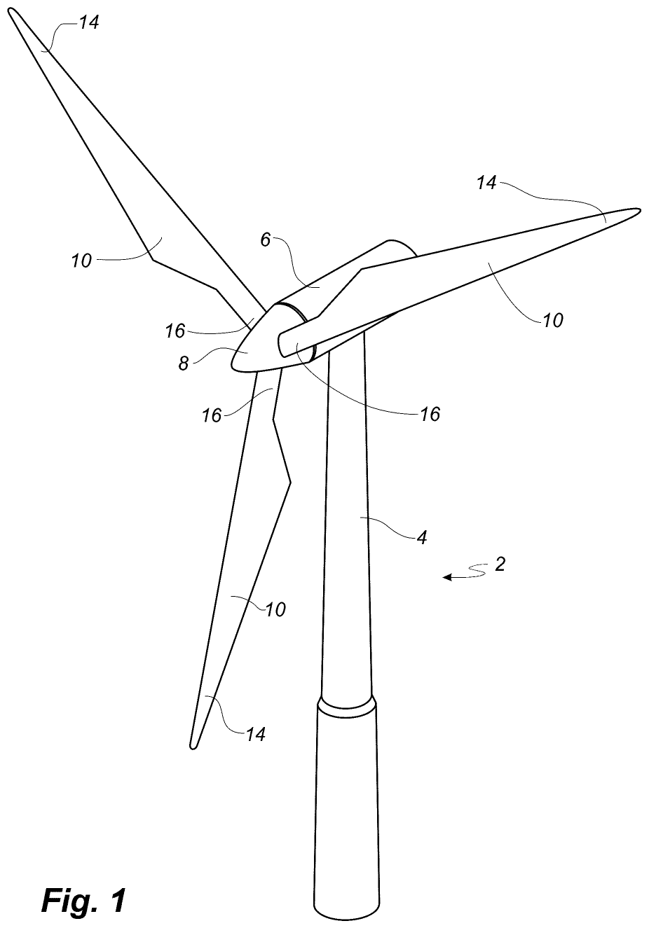

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

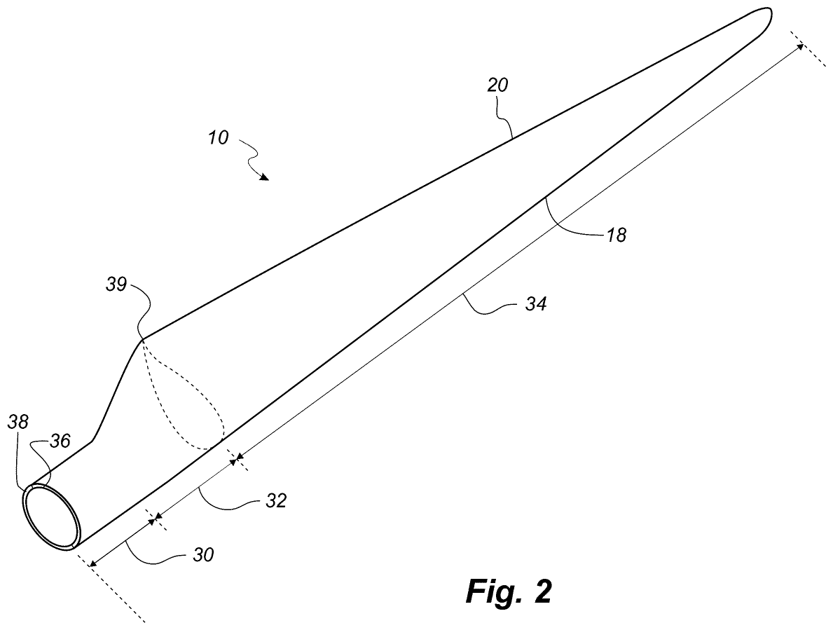

FIG. 2 shows a schematic view of a first embodiment of a wind turbine blade 10 disclosure. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10 when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 39 of the blade 10 is defined as the position, where the blade 10 has its largest chord length. The shoulder 39 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part 36 and a suction side shell part 38 that are glued to each other along bond lines at the leading edge 18 and the trailing edge 20 of the blade. The blade 10 comprises an exterior surface 11 of the blade 10.

In the following, the invention is explained with respect to arrangement of different surface-mounted devices on the exterior surface 11 of the blade 10.

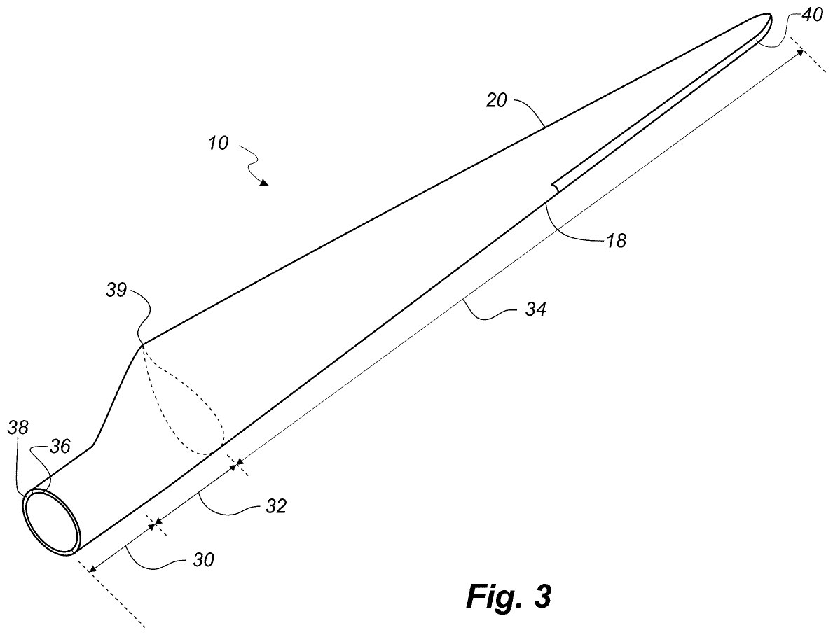

FIG. 3 shows a schematic view of a wind turbine blade 10 with a leading edge panel 40, e.g. a leading edge protection panel, such as an erosion protection panel, i.e. an erosion shield. The leading edge panel 40 is arranged on the leading edge 18 of the wind turbine blade 10. The leading edge panel 40 may for instance cover a bond line of the pressure side shell part 36 and a suction side shell part 38 at the leading edge 18 of the blade 10. The leading edge panel 40 extends in a longitudinal (or a spanwise) direction along the wind turbine blade 10 from the blade tip in a direction to the root region 30. The leading edge panel 40 may advantageously be arranged along e.g. the outer half or outer third of the blade only near the blade tip 14.

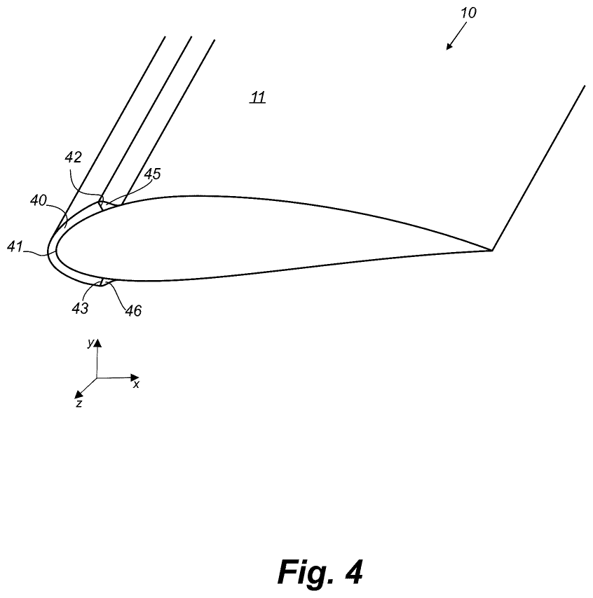

FIG. 4 illustrates a schematic view of the blade 10 with the leading edge panel 40. The leading edge panel 40 is arranged to be provided on the leading edge 18 of the wind turbine blade 10 across the bond line between the pressure side shell part 36 and the suction side shell part 38.

A base part 41 of the leading edge panel 40 is the most remote part from the exterior surface 11 of the blade 10. The base part 41 of the leading edge panel 40 provides a step up in height corresponding to the thickness of the leading edge panel 40 from the exterior surface 11 of the blade in the chordwise direction from a first side 42 of the base part 41 and from a second side 43 of the base part 41. A chamfer section 45 is arranged to provide a transition from the step in height from the first side 42 of the base part 41 to the exterior surface 11 of the wind turbine blade 10.

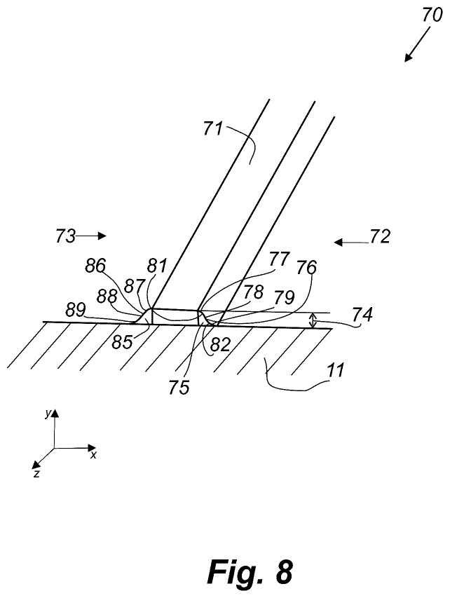

The chamfer section 45 comprises a tapered section tapering in thickness in a direction away from the first side 42 of the base part 41. Possible profiles of the tapered section are illustrated with the reference to FIGS. 8-10 and 12. XY is a chordwise plane of the chamfer section.

A second chamfer section 46 is arranged to provide a transition from the step in height from the second side 43 of the base part 41 to the exterior surface of the wind turbine blade 10. The chamfer section 46 comprises a tapered section tapering in thickness in a direction away from the second side 43 of the base part 41. Possible profiles of the tapered section are illustrated with the reference to FIGS. 8-10 and 12.

The leading edge panel 40 shown in FIGS. 3 and 4 may be, for example, a clip-on panel, which is arranged on the exterior surface 11 of the blade 10 by applying adhesive to contact points of the panels and the exterior surface 11 of the blade 10 and applying the pressure to the contact points to adhere the panels to the blade 10.

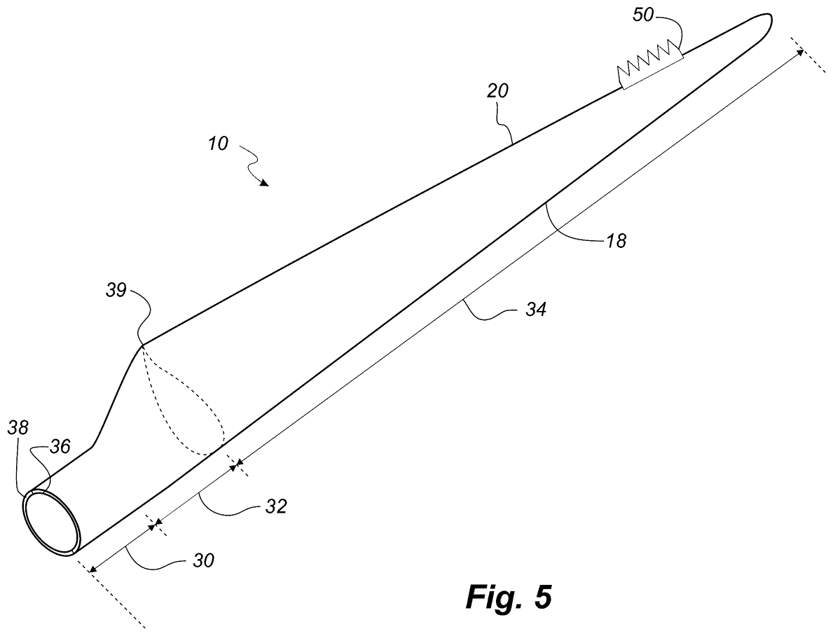

FIG. 5 shows a schematic view of a wind turbine blade 10 with a serration panel 50 on a trailing edge 20 of the blade 10. The serration panel 50 is arranged along a portion of the trailing edge 20 of the wind turbine blade 10. The serration panel 50 extends in a longitudinal (or a spanwise) direction along the wind turbine blade 10. While the serration panel 50 shown in FIG. 5 is arranged along an outboard portion of the blade 10, it is recognized that the serration panel 50 may be arranged, for example, closer to the root 16 of the blade, or that they may be arranged along, for example, the entire airfoil region 34 of the blade 10. Although only one serration panel 50 is shown in FIG. 5, it is recognized that an array of the serration panels 50 may be arranged on the wind turbine blade 50 in an embodiment. The serration panel 50 may comprise serration of different sizes, where serration sizes may depend on location of the serration panel 50 relative to the tip 14 of the blade 10.

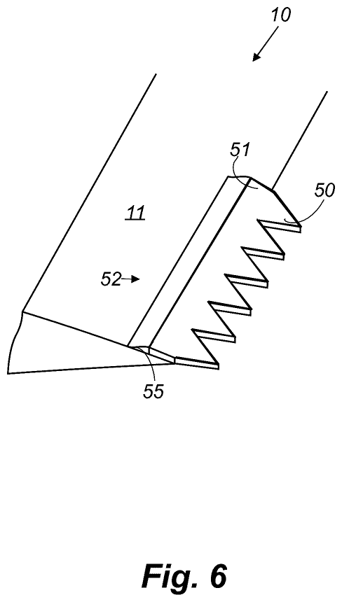

FIG. 6 illustrates a schematic view of the blade 10 with the serration panel 50. A base part 51 of the serration panel 50 is utilised to mount the serration panel 50 to the exterior surface 11 of the blade 10. The base part 51 of the serration panel 50 provides a step up in height corresponding to the thickness of the serration panel 50 from the exterior surface 11 of the blade in the chordwise direction from a first side 52 of the base part 51. A chamfer section 55 is arranged to provide a transition from the step in height of the base part 51 to the exterior surface of the wind turbine blade 10. The chamfer section 55 comprises a tapered section tapering in thickness away from the first side 52 of the base part 51. Possible profiles of the tapered section are illustrated with the reference to FIGS. 8-10 and 12.

In case an array of the serration panels 50 may be arranged on the wind turbine blade 10 in an embodiment, a plurality of corresponding chamfer regions may be arranged to provide a transition between each of the serration panels 50 of the array to the exterior surface 11 of the blade 10.

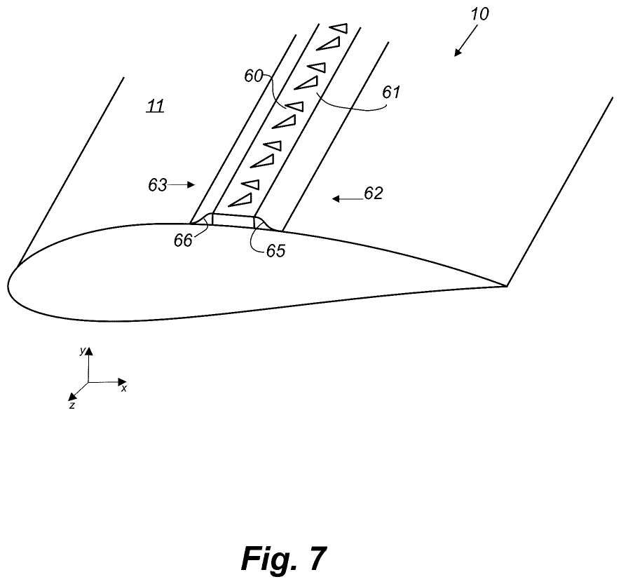

FIG. 7 shows a schematic view of a wind turbine blade 10 provided with a vortex generator panel 60. The vortex generator panel 60 is arranged on an exterior surface of a suction side shell part 38 of the blade 10. The vortex generator panel 60 may be located between the root 16 of the blade 10 and the tip 14 of the blade 10. The vortex generator panel 60 may be located in the root region 30, and/or the transition region 32, and/or the airfoil region 34 of the blade 10. The vortex generator panel 60 comprises at least one vortex generator. The vortex generator panel 60 may for instance as shown comprise a base part 61, which comprises vane sets of vortex generators 67.

Although one vortex generator panel 60 is shown in FIG. 7, a plurality of the vortex generator panels 60 could be arranged on the exterior surface 11 of the blade 10.

The base part 61 of the vortex generator panel 60 provides a step up in height corresponding to the thickness of the vortex generator panel 60 from the exterior surface 11 of the blade 10 in the chordwise direction from both a first side 62 of the base part 61 and from a second side 63 of the base part 61. A chamfer section 65 is arranged to provide a transition from the step in height from the first side 62 of the base part 61 to the exterior surface 11 of the wind turbine blade 10. The chamfer section 65 comprises a tapered section tapering in thickness in a direction away from the first side 62 of the base part 61. The profile of the tapered section may for instance be as illustrated with the reference to FIGS. 8-10 and 12. XY is a chordwise plane of the chamfer section.

A second chamfer section 66 is arranged to provide a transition from the step in height from the second side 63 of the base part 61 to the exterior surface 11 of the wind turbine blade 10. The second chamfer section 66 comprises a tapered section tapering in thickness in a direction away from the second side 63 of the base part 61. The profile of the tapered section may for instance be as illustrated with the reference to FIGS. 8-10.

FIG. 8 illustrates a schematic view of a chamfer section providing a transition from a base part 71 of a surface-mounted device 70 and an exterior surface 11 of the wind turbine blade 10. In embodiments, the surface-mounted device 70 may correspond to any of the leading edge panel 40, the serration panel 50, or the vortex generator panel 60 shown in FIGS. 3 to 7. Similarly, the base part 71 may correspond to the base part 41, or the base part 51, or the base part 61. The surface-mounted device 70 could also be any other surface-mounted device configured to be arranged on the exterior surface 11 of the blade 10.

A step 74 up in height as shown in FIG. 8 is provided by the base part 71 of the surface-mounted device 70 from the exterior surface 11 of the blade in the chordwise direction from a first side 72 and from a second side 73 of the base part 71. The step 74 up in height corresponds to a thickness of the base part 71 of the surface-mounted device 70 or the thickness of the surface-mounted device itself. A chamfer section 75 is arranged to provide a transition from the step 74 in height from the first side 72 of the base part 71 to the exterior surface 11 of the blade 10. XY is a chordwise plane of the chamfer section.

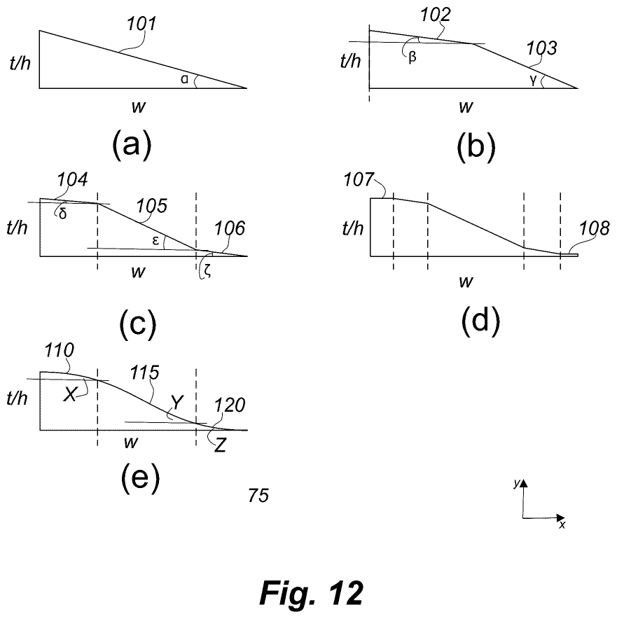

An example of a cross-sectional profile of the chamfer section 75 in the chordwise direction can be seen in FIG. 8. The chamfer section 75 comprises a tapered section 76 tapering in thickness away from the first side 72 of the base part 71. The tapered section 76 comprises a first tapered section 77, a second tapered section 78, and a third tapered section 79. The first tapered section 77 is proximal to the first side 72 of the base part 71 and having a first average taper angle. The third tapered section 79 is distal to the first side 72 of the base part 71 and having a third average taper angle. The second tapered section 78 is between the first tapered section 77 and the third tapered section 79 and having a second average taper angle. The second average taper angle is larger than both the first average taper angle and the third average taper angle. Accordingly, it is seen that tapered section 76 comprises a section 77 with a shallow taper angle near the start of the tapered section, a middle section 78 with a larger taper angle, and a section 79 with a shallow taper angle near the exterior surface 11 of the blade 10. Thereby, a multi-slope transition is obtained in the longitudinal (or spanwise) direction of the blade, which is particular advantageous, when mounting the chamfer section 75 on the exterior surface 11 of the blade 10. A reference point for the taper angles measurement is the thickness or the height of the base part 71 of the surface-mounted device 70 at the first side 72 of the base 71. The taper angles are shown and explained in detail with the reference to FIG. 12.

The tapered section 76 starts with a tangential angle parallel to an upper surface of the base part 71 and also ends with an angle that is substantially parallel (or has a low acute angle) to the blade surface.

The tapered section 76 basically comprises a first concave portion 81 proximal to the first side 72 of the base part 71 and a second convex portion 82 distal to the first side 72 of the base part 71 of the surface-mounted device. The first concave portion 81 is formed by the first tapered section 77 and by a portion of the second tapered section 78. The second concave portion 82 is formed by a portion of the second tapered section 78 and by the third tapered section 79.

A variable sectional profile of the tapered section 76 is thus provided. The variable sectional profile may for instance start substantially flush from the base part 71 and then curve concavely from the base part 71 and then change to a convex curve, such that the tapered section 76 lands substantially flush with the exterior surface 11 of the blade 10 at a predetermined distance from the side of the base part 71, which may reduce drag and noise and may further improve lift of the resulting profile.

The tapered section 76 basically comprises: a first curvature region proximal to the first side 72 of the base plate 72 and having an outer radius of curvature, wherein the first curvature region has an intersection length, and a second curvature region distal to the first side 72 of the base plate 72 and having an inner radius of curvature. This provides a particular simple way of providing a substantially S-shaped profile.

Depending on the surface-mounted device 70, only one chamfer section 75 could be provided or a second chamfer section 85, which is similar to the chamfer section 75, could be provided as well to transition from the step 74 in height of the base part 71 from the second side 73 to the exterior surface 11 of the blade 10.

A cross-sectional profile of the second chamfer section 85 in the chordwise direction can also be seen in FIG. 8. The chamfer section 85 comprises a tapered section 86, similar to the tapered section 76, tapering in thickness away from the second side 73 of the base part 71. The tapered section 86 comprises a first tapered section 87, a second tapered section 88, and a third tapered section 89. The first tapered section 87 is proximal to the first side 82 of the base part 71 and having a first average taper angle. The third tapered section 89 is distal to the first side 82 of the base part 71 and having a third average taper angle. The second tapered section 88 is between the first tapered section 86 and the third tapered section 88 and having a second average taper angle. The second average taper angle is larger than both the first average taper angle and the third average taper angle.

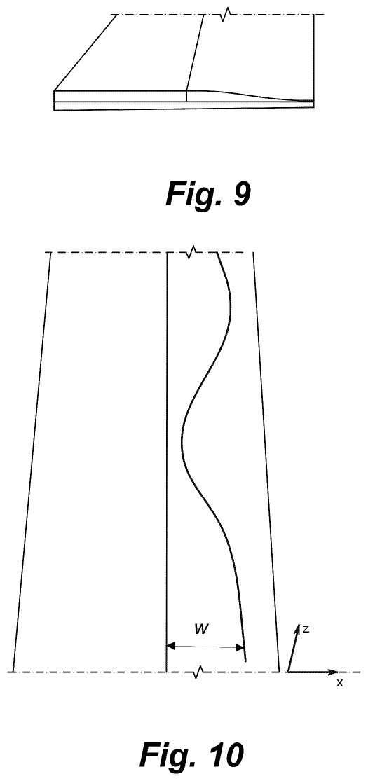

FIG. 9 shows a sectional view of a chamfer section in accordance with the current disclosure, which comprises a tapered section as described in relation to FIG. 8 and has, for example, a substantially S-shaped profile.

FIG. 10 shows a top view of a chamfer section. In the embodiment shown in FIG. 10, the width of the chamfer section varies in the spanwise direction. This width may alternatively be referred to as a maximum width of the chamfer section, as it is measured on the plane x-z which contains the maximum width of the chamfer section.

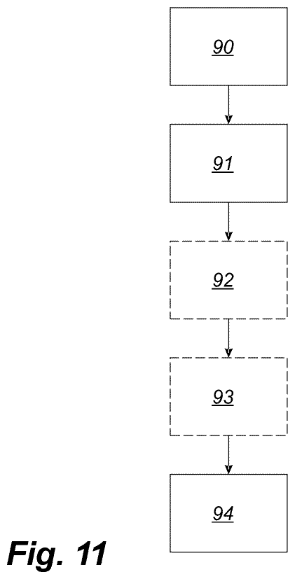

In the following, a method of manufacturing of a wind turbine blade according to the present disclosure is described. The method comprises the steps shown in FIG. 11.

In a first step 90, a surface-mounted device is arranged on an exterior surface of the blade, wherein a base part of the surface-mounted device providing a step in height from the exterior surface of the blade in the chordwise direction from a first side of the base part. In a second step 91, a chamfer section is arranged, the chamfer section having a cross-sectional profile as seen in the chordwise direction and configured to provide a multi-slope transition from the step in height of the base part to the exterior surface. Second step 91 may optionally include applying the chamfer section on the exterior surface of the blade in contact with the first side of the base part of the surface-mounted device.

In an optional third step 92, the chamfer section is arranged to abut the base part of the surface-mounted device so that a surface of the chamfer section extends substantially flush from the first side of the base part. In an optional fourth step 93, the chamfer section is arranged to abut the exterior surface of the blade so that the chamfer section curvilinearly transitions into the exterior surface of the blade. Basically, the tapered section is mounted to the blade surface. In a fifth step 94, a tapered section of the chamfer section is provided, wherein the tapered section tapers in thickness away from the first side of the base part.

Step 94 may optionally comprise integrally forming the chamfer section with the base part of the surface-mounted device. In this case, fifth step 94 is performed prior to first step 90. Further, the manufacturing method may optionally comprise a step of providing a 3-D or 5-axis printing or 5-axis milling to receive the chamfer section having the tapered section. In this case, both steps 91 and 94 are combined in one corresponding step. Further, the manufacturing method may optionally comprise molding the chamfer section, e.g. directly onto the exterior surface of the blade, e.g. using curing a layer of liquid material. However, having pre-manufactured tapering sections provides a simple way to manufacture the sections.

FIG. 12 shows schematic views of various examples for a chordwise cross-sectional profile of a tapered section, e.g. the tapered section 76 shown in FIG. 8. XY is a chordwise plane of the chamfer section.

The tapered section is defined by a thickness t or a height h. The thickness t or the height h is defined as a distance between a surface of the chamfer section 75 contacting the exterior surface 11 of the blade 10 and a line (or a point of the cross-sectional profile), where the chamfer section 75 is substantially flush with the base part 71 of the surface-mounted device 70. Thus, the thickness t or the height h preferably may correspond to the thickness or the height of the base part 71 of the surface-mounted device 70, as shown e.g. in FIG. 8. The tapered section is further defined by a width w. The width w is a distance between a surface of the chamfer section 75 contacting (or arranged adjacent to) the first side 72 of the base part 71 of the surface-mounted device 70 and a line (or a point of the cross-sectional profile), where the chamfer section 75 transitions or lands substantially flush with the exterior surface 11 of the blade 10. The tapered section may be also defined by a length (not shown in FIG. 12), which may correspond to a length of the base part 71 of the surface-mounted device 70, as seen in a spanwise direction of the blade.

The tapered section is also defined by taper angles. The taper angles of the tapered section or of the separate tapered sections of the tapered section are defined by the change in thickness or height divided by the width, or the change in the width, through the section (Δt/Δw or Δh/Δw).

FIG. 12(a) shows a rectilinear tapered section 101 having only a single rectilinear side with a taper angle a. This embodiment is particularly applicable to an embodiment, where the chordwise cross-sectional profile varies in the spanwise direction of the blade.

FIG. 12(b) shows a tapered section divided into two separate tapered rectilinear tapered sections 102 and 103 with different taper angles β and γ. The taper angle γ is greater than the taper angle β in the shown embodiment, but it is also envisioned that the taper angle β could be greater than the taper angle γ.

FIG. 12(c) shows a tapered section divided into three separate tapered sections 104, 105, 106 with different taper angles δ, ε, and ζ. The taper angle ε is greater than the taper angles δ and ζ. This provides a first embodiment having a first tapered section proximal to the first side of the base part and having a first average taper angle; a third tapered section distal to the first side of the base part and having a third average taper angle; and a second tapered section between the first tapered section and the third tapered section and having a second average taper angle, wherein the second average taper angle is greater than both the first average taper angle and the third average taper angle.

FIG. 12(d) shows a tapered section divided into five different sections with two flat sections 107 and 108. This provides a second embodiment having a first tapered section proximal to the first side of the base part and having a first average taper angle; a third tapered section distal to the first side of the base part and having a third average taper angle; and a second tapered section between the first tapered section and the third tapered section and having a second average taper angle, wherein the second average taper angle is greater than both the first average taper angle and the third average taper angle.

FIG. 12(e) shows a substantially S-shaped tapered section having three sections with three different average angles. The S-shaped tapered section has a first tapered section 110, a second tapered section 115, and a third tapered section 120 having a first average taper angle X, a second average taper angle Y, and a third average tapered angle Z correspondingly. The second average taper angle Y is greater than both the first average taper angle X and the third average taper angle Z. Thus, this embodiment provides a third embodiment, where a second average taper angle is greater than both the first average taper angle and the third average taper angle.

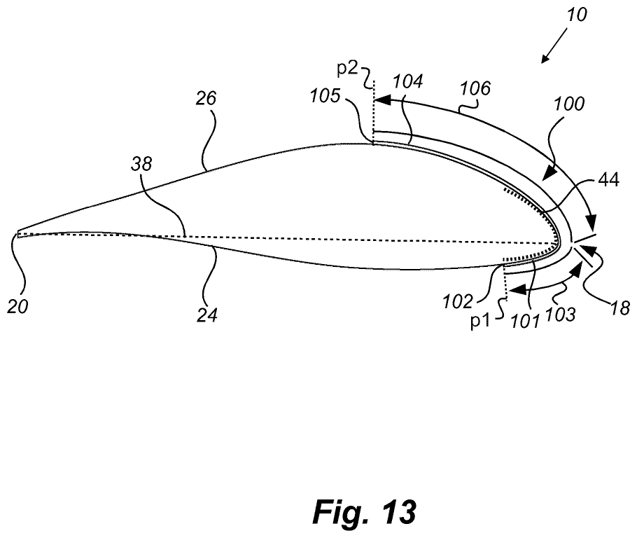

FIG. 13 shows a schematic cross-sectional view of a wind turbine blade 10, such as the wind turbine blade 10 of FIGS. 3-4, with a leading edge panel 40, e.g. proximal to the root. The wind turbine blade 10 comprises a leading edge 18, a trailing edge 20, a pressure side 24 and a suction side 26. The wind turbine blade 10 comprises a chord 38 between the leading edge 18 and the trailing edge 20. The wind turbine blade 10 has an erosion sensitive area 44, which is most sensitive to wear and tear over time. The wind turbine blade 10 may be protected by providing a leading edge protection panel 100 over the erosion sensitive area 44, such as the leading edge panel 40 of FIGS. 3-4.

The leading edge protection panel 100 comprises a first section 101 extending from the leading edge 18 and along a part of the pressure side 24 of the wind turbine blade 10 to a first transverse end 102 at a first position p1. The first section 101 has a first extent 103, in the circumferential direction, from the leading edge 18 of the wind turbine blade 10, e.g. from the end of the chord 38 at the leading edge, to the first position p1. The leading edge protection panel 100 comprises a second section 104 extending from the leading edge 18 and along a part of the suction side 26 of the wind turbine blade 10 to a second transverse end 105 at a second position p2. The second section 104 has a second extent 106, in the circumferential direction, from the leading edge 18 of the wind turbine blade 10, e.g. from the end of the chord 38 at the leading edge, to the second position p2.

The leading edge protection panel 100 may be arranged asymmetrically on the wind turbine blade 10 relative to the leading edge 18. A higher annual energy production may be provided by reducing the drag and increasing the lift of the wind turbine blade by extending the second extent 106 of the leading edge protection panel 100 on the suction side 26 and thus postponing the transition from laminar to turbulent flow of the boundary layer in flow direction on the suction side 26. Thus, the position p2 is located at a location where a transition from laminar to turbulent flow of the boundary layer provides the optimal lift and drag. This position point may be dependent on the type of blade and its geometry.

In FIG. 13, instead of a symmetrical arrangement of the leading edge protection panel 100 relative to the leading edge 18 of the wind turbine blade 10, the leading edge protection panel 100 is arranged asymmetrically (e.g. with respect to the leading edge 18). The second extent 106 is larger than the first extent 103. The first position p1 and the second position p2 are located beyond the boundary of the erosion sensitive area 44. The leading edge protection panel 100 may be arranged such that at least the erosion sensitive area 44 on the pressure side 24 is covered by the first extent 103, and such that the remainder of the leading edge protection panel 100 is arranged across the suction side 26 and extending to at least the optimal location of where a transition from laminar to turbulent flow of the boundary layer provides the optimal lift and drag.

The location of the first position p1 and second position p2 according to FIG. 13 should not be interpreted to be limiting. For example, the location of the first position p1 and second position p2 in FIG. 13 may be at the boundary of the erosion sensitive area 44. The leading edge protection panel 100 may be arranged such that the second extent 106 extends to at least the optimal location of where a transition for laminar to turbulent flow of the boundary layer provides the optimal lift the suction side 26, and such that the remainder of the leading edge protection panel 100 is arranged across the pressure side 24 and extending to at least the boundary of the erosion sensitive area 44.

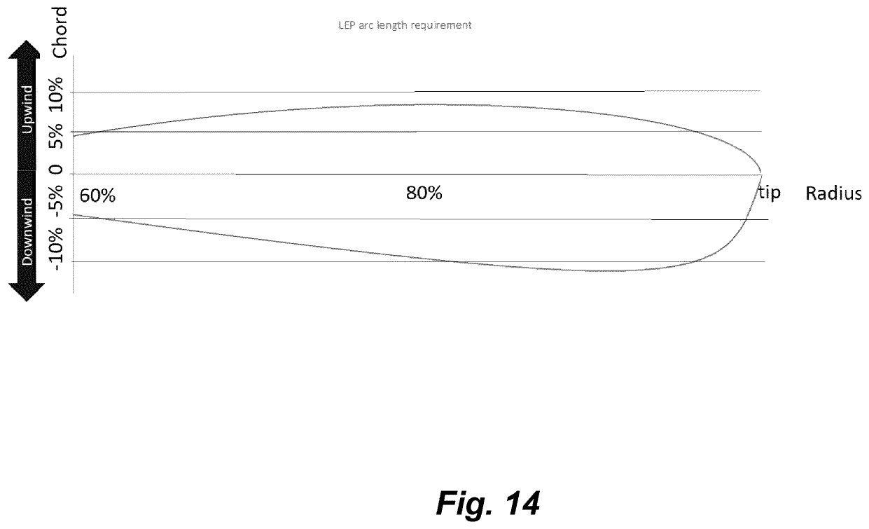

The length of the first extent 103 and the second extent 106 may vary in the spanwise direction, as shown in FIG. 14. A ratio between the second extent 106 and the first extent 103 may vary in the spanwise direction, as illustrated in FIG. 14, e.g. from 1:1 to at least 1.5:1. A center of the leading edge protection panel 100 may change in the spanwise (longitudinal) direction.

FIG. 14 shows an example of varying lengths of the first extent 103 and the second extent 106, shown in FIG. 13. FIG. 14 illustrates how the length of the first extent 103 (on the upwind side) and the length of the second extent 106 (on the downwind side) change along the spanwise (longitudinal) direction of the wind turbine blade. The first extent 103 and the second extent 106 are shown as measured in the circumferential direction and expressed as the arc length. Upper line in FIG. 14 shows change in length of the first extent 103 (on the upwind side) along the spanwise (longitudinal) direction of the wind turbine blade. Bottom line in FIG. 14 shows change in length of the second extent 106 (on the downwind side) along the spanwise (longitudinal) direction of the wind turbine blade.

FIG. 14 illustrates a changing (varying) ratio between the second extent 106 and the first extent 103.

For reasons of completeness, exemplary embodiments of the present disclosure are set out in the following items:

Item 1. A wind turbine blade, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade, wherein the surface-mounted device comprises a base part, the base part providing a step in height from the exterior surface of the blade in the chordwise direction from a first side of the base part, wherein the blade further comprises a chamfer section arranged and configured to provide a transition from the step in height of the base part to the exterior surface, wherein the chamfer section has a cross-sectional profile as seen in the chordwise direction, wherein the chamfer section comprises a tapered section, wherein the tapered section tapers in thickness away from the first side of the base part and comprises: a first tapered section proximal to the first side of the base part and having a first average taper angle; a third tapered section distal to the first side of the base part and having a third average taper angle; and a second tapered section between the first tapered section and the third tapered section and having a second average taper angle, wherein the second average taper angle is larger than both the first average taper angle and the third average taper angle.

Item 2. The wind turbine blade according to item 1, wherein the tapered section has a substantially S-shaped profile in the spanwise direction of the blade.

Item 3. The wind turbine blade according to any of items 1-2, wherein the first side of the base part of the surface-mounted device is straight; and wherein the tapered section has a first straight side adjacent to the first straight side of the base part.

Item 4. The wind turbine blade according to any of the preceding items, wherein the chamfer section substantially abuts the base part of the surface-mounted device and extends substantially flush from the first side of the base part.

Item 5. The wind turbine blade according to any of the preceding items, wherein the chamfer section substantially abuts the exterior surface of the blade and smoothly transitions into the exterior surface of the blade.

Item 6. The wind turbine blade according to any of items 2-5, wherein the first average taper angle, the second average taper angle, and the third average taper angle are varying angles.

Item 7. The wind turbine blade according to item 1, wherein the tapered section comprises a first concave portion proximal to the first side of the base part and a second convex portion distal to the first side of the base part.

Item 8. The wind turbine blade according to any of the preceding items, wherein a chordwise width of the chamfer section varies in the spanwise direction of the wind turbine blade.

Item 9. The wind turbine blade according to any of the preceding items, wherein the chamfer section has a varying height in a spanwise direction of the wind turbine blade.

Item 10. The wind turbine blade according to any of the preceding items, wherein a cross-sectional shape of the chamfer section varies in the spanwise direction of the wind turbine blade.

Item 11. The wind turbine blade according to any of the preceding items, wherein the chamfer section is integrally formed with the surface-mounted device.

Item 12. The wind turbine blade according to any of items 1-10, wherein the chamfer section is a section arranged on the exterior surface of the blade in contact with the first side of the base part.

Item 13. The wind turbine blade according to any of the preceding items, wherein the chamfer section has a height to width ratio in the range 1:2 to 1:60, preferably in the range 1:10 to 1:30, e.g. around 1:20.

Item 14. The wind turbine blade according to any of the preceding items, wherein the chordwise direction width of the chamfer section is between 3 mm and 20 mm, preferably between 5 mm and 15 mm, e.g. around 12 mm.

Item 15. The wind turbine blade according to any of the preceding items, wherein the length of the chamfer section is between 10 mm and 5000 mm, preferably between 30 mm and 2000 mm, e.g. around 700 mm, or e.g., around 500 mm.

Item 16. The wind turbine blade according to any of the preceding items, wherein the chamfer section comprises a top cover.

Item 17. The wind turbine blade according to any of the preceding items, wherein the surface-mounted device is one of the following: a leading edge panel; a clip-on leading edge panel; a vortex generator panel; a spoiler panel; a serration panel; a trailing edge serration panel.

Item 18. Method of manufacturing of a wind turbine blade, the method comprising: arranging a surface-mounted device on an exterior surface of the blade, wherein a base part of the surface-mounted device provides a step in height from the exterior surface of the blade in the chordwise direction from a first side of the base part; arranging a chamfer section having a cross-sectional profile as seen in the chordwise direction and configured to provide a curvilinear transition from the step in height of the base part to the exterior surface, wherein arranging the chamfer section comprises providing a tapered section of the chamfer section, wherein the tapered section tapers in thickness away from the first side of the base part.

Item 19. The method according to item 18, wherein the method further comprises using a 3-D printing step, and/or a 5-axis printing step and/or a 5-axis milling step to provide the chamfer section having the tapered section.

Item 20. The method according to any of items 18-19, wherein the method further comprises substantially abutting the chamfer section to the base part of the surface-mounted device so that the chamfer section extends substantially flush from the first side of the base part.

Item 21. The method according to any of items 18-20, wherein the method further comprises substantially abutting the chamfer section to the exterior surface of the blade so that the chamfer section smoothly transitions to the exterior surface of the blade.

Item 22. The method according to any of items 18-21, wherein the method further comprises integrally forming the chamfer section with the base plate of the surface-mounted device prior to arranging the surface-mounted device on the exterior surface of the blade.

Item 23. The method according to any of items 18-21, wherein the method further comprises applying the chamfer section on the exterior surface of the blade in contact with the first side of the base part of the surface-mounted device after arranging the surface-mounted device on the exterior surface of the blade.

Item 24. The method according to any of items 18-23, wherein the chamfer section is manufactured using molding the chamfer section by injection and curing of a liquid material.

Item 25. A wind turbine blade, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade, wherein the surface-mounted device comprises a base part, the base part providing a step in height from the exterior surface of the blade in the chordwise direction from a first side of the base part, wherein the blade further comprises a chamfer section arranged and configured to provide a smooth transition from the step in height of the base part to the exterior surface, wherein the chamfer section has a cross-sectional profile as seen in the chordwise direction, wherein the cross-sectional profile of the chamfer section varies in the spanwise direction of the blade.

Item 27. A wind turbine blade, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade, wherein the surface-mounted device comprises a base part, the base part providing a step in height from the exterior surface of the blade in the chordwise direction from a first side of the base part, wherein the blade further comprises a chamfer section arranged and configured to provide a smooth transition from the step in height of the base part to the exterior surface, wherein the chamfer section has a cross-sectional profile as seen in the chordwise direction, wherein a width of the cross-sectional profile of the chamfer section varies in the spanwise direction of the blade.

Item 28. A wind turbine blade, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade, wherein the surface-mounted device comprises a base part, the base part providing a step in height from the exterior surface of the blade in the chordwise direction from a first side of the base part, wherein the blade further comprises a chamfer section configured to provide a curvilinear transition from the step in height of the base part to the exterior surface, wherein a chordwise cross-sectional profile taken along a chordwise plane of the chamfer section varies in the chordwise direction and/or in the spanwise direction of the wind turbine blade.

Item 29. The wind turbine blade according to item 28, wherein a width of the chordwise cross-sectional profile of the chamfer section varies in the chordwise direction and/or in the spanwise direction of the wind turbine blade.

Item 30. The wind turbine blade according to any of items 28-29, wherein the chamfer section comprises a first concave portion proximal to the first side of the base part and a second convex portion distal to the first side of the base part.

Item 31. The wind turbine blade according to any of items 28-30, wherein the chamfer section comprises a tapered section, wherein the tapered section tapers in thickness away from the first side of the base part and comprises: a first tapered section proximal to the first side of the base part and having a first average taper angle; a third tapered section distal to the first side of the base part and having a third average taper angle; and a second tapered section between the first tapered section and the third tapered section and having a second average taper angle, wherein the second average taper angle Y is greater than both the first average taper angle X and the third average taper angle Z.

Item 32. The wind turbine blade according to item 31, wherein the chamfer section has a substantially S-shaped profile in the chordwise direction of the wind turbine blade.

Item 33. The wind turbine blade according to any of items 31-32, wherein the first average taper angle X, the second average taper angle Y, and the third average taper angle Z are varying angles.

Item 34. The wind turbine blade according to any of items 31-33, wherein the first side of the base part of the surface-mounted device is rectilinear; and wherein the tapered section has a first rectilinear side adjacent to the first rectilinear side of the base part.

Item 35. The wind turbine blade according to any of items 28-34, wherein the chamfer section substantially abuts the base part of the surface-mounted device and extends substantially flush from the first side of the base part.

Item 36. The wind turbine blade according to any of items 28-35, wherein the chamfer section substantially abuts the exterior surface of the blade and transitions curvilinearly into the exterior surface of the blade.

Item 37. The wind turbine blade according to any of items 28-36, wherein the chamfer section is integrally formed with the surface mounted device.

Item 38. The wind turbine blade according to any of items 28-36, wherein the chamfer section is a section arranged on the exterior surface of the blade in contact with the first side of the base part.

Item 39. The wind turbine blade according to any of items 28-38, wherein the chamfer section has a height to width ratio in the range 1:2 to 1:60, preferably in the range 1:10 to 1:30, e.g. around 1:20.

Item 40. The wind turbine blade according to any of items 28-39, wherein the width of the chamfer section is between 3 mm and 20 mm, preferably between 5 mm and 15 mm, e.g. around 12 mm.

Item 41. The wind turbine blade according to any of items 28-40, wherein the length of the chamfer section is between 10 mm and 500 mm, preferably between 30 mm and 200 mm, e.g. around 70 mm, or e.g., around 50 mm.

Item 42. The wind turbine blade according to any of items 28-41, wherein the chamfer section comprises a top cover.

Item 43. The wind turbine blade according to any of items 28-42, wherein the surface-mounted device is one of the following: a leading edge panel; a clip-on leading edge panel; a vortex generator panel; a spoiler panel; a serration panel; a trailing edge serration panel.

Item 44. Method of manufacturing of a wind turbine blade, the method comprising: arranging a surface-mounted device on an exterior surface of the blade, wherein a base part of the surface-mounted device provides a step in height from the exterior surface of the blade in the chordwise direction from a first side of the base part; arranging a chamfer section configured to provide a multi-slope transition from the step in height of the base part to the exterior surface, wherein arranging the chamfer section comprises providing a chordwise cross-sectional profile taken along a chordwise plane of the chamfer section varying in the chordwise direction and/or in a spanwise direction of the wind turbine blade.

Item 45. The method according to item 44, wherein arranging the chamfer section further comprises providing a tapered section of the chamfer section, wherein the tapered section tapers in thickness away from the first side of the base part.

Item 46. The method according to any of items 44-45, wherein the method further comprises using a 3-D printing step, and/or a 5-axis printing step and/or a 5-axis milling step to provide the chamfer section.

Item 47. The method according to any of items 44-46, wherein the method further comprises substantially abutting the chamfer section to the base part of the surface-mounted device so that the chamfer section extends substantially flush from the first side of the base part.

Item 48. The method according to any of items 44-47, wherein the method further comprises substantially abutting the chamfer section to the exterior surface of the blade so that the chamfer section curvilinearly transitions to the exterior surface of the blade.

Item 49. The method according to any of items 44-48, wherein the method further comprises integrally forming the chamfer section with the base plate of the surface-mounted device prior to arranging the surface-mounted device on the exterior surface of the blade.

Item 50. The method according to any of items 44-49, wherein the method further comprises applying the chamfer section on the exterior surface of the blade in contact with the first side of the base part of the surface-mounted device after arranging the surface-mounted device on the exterior surface of the blade.

Item 51. The method according to any of items 44-50, wherein the chamfer section is manufactured using molding the chamfer section by injection and curing of a liquid material.

Item 52. The method according to any of items 44-51, wherein the chamfer section is configured to provide a curvilinear multi-slope transition from the step in height of the base part to the exterior surface.

Item 53. The method according to any of items 44-52, wherein the chamfer section comprises a tapered section, wherein the tapered section tapers in thickness away from the first side of the base part and comprises:
a first tapered section proximal to the first side of the base part and having a first average taper angle;
and
a second tapered section distal to the first side of the base part and having a second average taper angle different from the first taper angle.

Item 54. A wind turbine blade, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade,
wherein the surface-mounted device is a leading edge protection panel attached to the leading edge of the wind turbine blade, the leading edge protection panel extending in the spanwise direction comprising:
   a first section extending from the leading edge and along a part of the pressure side of the wind turbine blade to a first transverse end at a first position on the pressure side of the blade, the first section having a first extent from the leading edge of the wind turbine blade to the first position on the pressure side of the blade, and
   a second section extending from the leading edge and along a part of the suction side of the wind turbine blade to a second transverse end at a second position on the suction side of the blade, the second section having a second extent from the leading edge of the wind turbine blade to the second position on the suction side of the blade, and
   the first extent and the second extent having varying lengths in the spanwise direction, and
   a ratio between the second extent and the first extent varying in the spanwise direction.

Item 55. The wind turbine blade according to Item 54, wherein the ratio between the second extent and the first extent varies from 1:1 to at least 1.5:1.

The scope of the invention is not limited to the illustrated embodiments, and alterations and modifications can be carried out without deviating from the scope of the invention.

Throughout the description, the use of the terms “first”, “second”, “third”, “fourth”, “primary”, “secondary”, “tertiary” etc. does not imply any particular order or importance, but are included to identify individual elements. Furthermore, the labelling of a first element does not imply the presence of a second element and vice versa.

### LIST OF REFERENCES

2 wind turbine
4 tower
6 nacelle
8 hub
10 blade
11 exterior surface of blade
14 blade tip
16 blade root
18 leading edge
20 trailing edge
24 pressure side
26 suction side
30 root region
32 transition region
34 airfoil region
36 pressure side shell
38 suction side shell
39 shoulder
40 leading edge panel
41 base part of leading edge panel
42 first side of base part of leading edge panel
43 second side of base part of leading edge panel
45 chamfer section
46 second chamfer section
50 serration panel
51 base part of serration panel
52 first side of base part of serration panel
55 chamfer section
60 vortex generator panel
61 base part of vortex generator panel
62 first side of base part of vortex generator panel
63 second side of base part of vortex generator panel
65 chamfer section
66 second chamfer section
70 surface-mounted device
71 base part of surface-mounted device
72 first side of base part of surface-mounted device
73 second side of base part of surface-mounted device
74 step up in height
75 chamfer section
76 tapered section of chamfer section
77 first tapered section of tapered section of chamfer section
78 second tapered section of tapered section of chamfer section
79 third tapered section of tapered section of chamfer section
85 second chamfer section
86 tapered section of second chamfer section
87 first tapered section of tapered section of second chamfer section
88 second tapered section of tapered section of second chamfer section
89 third tapered section of tapered section of second chamfer section
90-94 method steps
101-120 tapered sections
α, β, γ, δ, ε, ζ taper angles
X first taper angle
Y second taper angle
Z third taper angle

1. A wind turbine blade, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade,
wherein the surface-mounted device is a leading edge protection panel attached to the leading edge of the wind turbine blade, the leading edge protection panel extending in the spanwise direction comprising:
a first section extending from the leading edge and along a part of the pressure side of the wind turbine blade to a first transverse end at a first position on the pressure side of the blade, the first section having a first extent from the leading edge of the wind turbine blade to the first position on the pressure side of the blade, and
a second section extending from the leading edge and along a part of the suction side of the wind turbine blade to a second transverse end at a second position on the suction side of the blade, the second section having a second extent from the leading edge of the wind turbine blade to the second position on the suction side of the blade, and
the first extent and the second extent having varying lengths in the spanwise direction, and
a ratio between the second extent and the first extent varying in the spanwise direction.

2. The wind turbine blade according to claim 1, wherein the ratio between the second extent and the first extent varies from 1:1 to at least 1.5:1.

3. A wind turbine blade, wherein the blade has a profiled contour including a pressure side and a suction side, and a leading edge and a trailing edge with a chord having a chord length extending therebetween in a chordwise direction, the wind turbine blade extending in a spanwise direction between a root end and a tip end, wherein the blade comprises a surface-mounted device arranged on an exterior surface of the blade,
wherein the surface-mounted device comprises a base part, the base part providing a step in height from the exterior surface of the blade in the chordwise direction from a first side of the base part,
wherein the blade further comprises a chamfer section configured to provide a multi-slope transition from the step in height of the base part to the exterior surface.

4. The wind turbine blade according to claim 3, wherein a maximum width (w) chamfer section varies in the spanwise direction of the wind turbine blade.

5. The wind turbine blade according to claim 3, wherein the chamfer section is configured to provide a curvilinear multi-slope transition from the step in height of the base part to the exterior surface.

6. The wind turbine blade according to claim 3, wherein the chamfer section comprises a first concave portion proximal to the first side of the base part and a second convex portion distal to the first side of the base part.

7. The wind turbine blade according to claim 3, wherein the chamfer section comprises a tapered section, wherein the tapered section tapers in thickness away from the first side of the base part and comprises:
a first tapered section proximal to the first side of the base part and having a first average taper angle;
and
a second tapered section distal to the first side of the base part and having a second average taper angle different from the first taper angle.

8. The wind turbine blade according to claim 3, wherein the chamfer section comprises a tapered section, wherein the tapered section tapers in thickness away from the first side of the base part and comprises:
a first tapered section proximal to the first side of the base part and having a first average taper angle;
a third tapered section distal to the first side of the base part and having a third average taper angle; and
a second tapered section between the first tapered section and the third tapered section and having a second average taper angle,
wherein the second average taper angle Y is greater than both the first average taper angle X and the third average taper angle Z.

9. The wind turbine blade according to claim 6, wherein the first side of the base part of the surface-mounted device is rectilinear; and wherein the tapered section has a first rectilinear side adjacent to the first rectilinear side of the base part.

10. The wind turbine blade according to claim 3, wherein the chamfer section substantially abuts the base part of the surface-mounted device and extends substantially flush from the first side of the base part, and/or wherein the chamfer section substantially abuts the exterior surface of the blade and transitions curvilinearly into the exterior surface of the blade.

11. The wind turbine blade according to claim 3, wherein the chamfer section is integrally formed with the surface mounted device, or
wherein the chamfer section is a section arranged on the exterior surface of the blade in contact with the first side of the base part.

12. The wind turbine blade according to claim 3, wherein the chamfer section has a height to width ratio in the range 1:2 to 1:60, preferably in the range 1:10 to 1:30, e.g. around 1:20, and/or
wherein the width of the chamfer section is between 3 mm and 20 mm, preferably between 5 mm and 15 mm, e.g. around 12 mm, and/or
wherein the length of the chamfer section is between 10 mm and 5000 mm, preferably between 30 mm and 2000 mm, e.g. around 700 mm, or e.g., around 500 mm.

13. The wind turbine blade according to claim 3, wherein the chamfer section comprises a top cover.

14. The wind turbine blade according to claim 3, wherein the surface-mounted device is one of the following: a leading edge panel; a clip-on leading edge panel; a vortex generator panel; a spoiler panel; a serration panel; a trailing edge serration panel.

15. Method of manufacturing of a wind turbine blade, the method comprising:
arranging a surface-mounted device on an exterior surface of the blade, wherein a base part of the surface-mounted device provides a step in height from the exterior surface of the blade in the chordwise direction from a first side of the base part;
arranging a chamfer section configured to provide a multi-slope transition from the step in height of the base part to the exterior surface.

16. The method according to claim 15, wherein arranging the chamfer section comprises providing a chamfer section with a varying width in a spanwise direction of the wind turbine blade.

17. The method according to claim 15, wherein the method further comprises using a 3-D printing step, and/or a 5-axis printing step and/or a 5-axis milling step to provide the chamfer section.
